(19) United States
(12) Patent Application Publication
(10) Pub. No.: US 2025/0236118 A1
(43) Pub. Date: Jul. 24, 2025

(54) CONTROL SYSTEM FOR FACILITY EQUIPMENT AND CONTROL METHOD FOR FACILITY EQUIPMENT

(71) Applicants: Keisuke Yuasa, KANAGAWA (JP); Naoto Suzuki, KANAGAWA (JP); Noriaki Fukube, KANAGAWA (JP); Sho Sawahata, TOKYO (JP); Yuji Karikusa, KANAGAWA (JP); Tetsuya Ohba, KANAGAWA (JP); Jun Matsushima, KANAGAWA (JP); Hirokazu Ikenoue, TOKYO (JP); Junichi Matsumoto, KANAGAWA (JP); Yoshiaki Hoshino, KANAGAWA (JP)

(72) Inventors: Keisuke Yuasa, KANAGAWA (JP); Naoto Suzuki, KANAGAWA (JP); Noriaki Fukube, KANAGAWA (JP); Sho Sawahata, TOKYO (JP); Yuji Karikusa, KANAGAWA (JP); Tetsuya Ohba, KANAGAWA (JP); Jun Matsushima, KANAGAWA (JP); Hirokazu Ikenoue, TOKYO (JP); Junichi Matsumoto, KANAGAWA (JP); Yoshiaki Hoshino, KANAGAWA (JP)

(73) Assignee: Ricoh Company, Ltd., Tokyo (JP)

(21) Appl. No.: 19/024,526

(22) Filed: Jan. 16, 2025

(30) Foreign Application Priority Data
Jan. 24, 2024 (JP) 2024-008714

(51) Int. Cl. B41J 11/00; B41J 3/54; B41J 29/377

(52) U.S. Cl. CPC B41J 11/00222; B41J 3/543; B41J 29/377

(57) ABSTRACT

A control system for facility equipment includes a liquid applying apparatus, an exhaust device, an air conditioner, and processing circuitry. The liquid applying apparatus includes a liquid applying device to apply liquid to an object, and a heating device to heat the object on which the liquid has been applied. The exhaust device exhausts air inside a space in which the liquid applying apparatus is placed. The air conditioner adjusts air environment inside the space. The processing circuitry controls the exhaust device and the air conditioner according to a state of the liquid applying apparatus.

### CROSS-REFERENCE TO RELATED APPLICATION

This patent application is based on and claims priority pursuant to 35 U.S.C. § 119(a) to Japanese Patent Application No. 2024-008714, filed on Jan. 24, 2024, in the Japan Patent Office, the entire disclosure of which is hereby incorporated by reference herein.

### BACKGROUND

### Technical Field

The present disclosure relates to a control system for facility equipment and a control method for the facility equipment.

### Related Art

Liquid applying apparatuses including a dryer are known. Such a liquid applying apparatus apples liquid to a sheet such as paper, and the dryer dries the sheet on which the liquid has been applied.

For example, a method has been proposed that collects heat of the air exhausted from a dryer and returns the collected heat to the dryer to reduce the demand for energy of a drying system that dries printed matter immediately after a printing operation.

### SUMMARY

The present disclosure described herein provides a control system for facility equipment. The control system includes a liquid applying apparatus, an exhaust device, an air conditioner, and processing circuitry. The liquid applying apparatus includes a liquid applying device to apply liquid to an object, and a heating device to heat the object on which the liquid has been applied. The exhaust device exhausts air inside a space in which the liquid applying apparatus is placed. The air conditioner adjusts air environment inside the space. The processing circuitry controls the exhaust device and the air conditioner according to a state of the liquid applying apparatus.

The present disclosure also provides a control method for facility equipment. The control method includes controlling an exhaust device to exhaust air inside a space in which a liquid applying apparatus that applies liquid to an object is placed, and an air conditioner to adjust air environment inside the space according to a state of the liquid applying apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image formation facility according to a first embodiment of the present disclosure;

FIG. 2 is a schematic diagram illustrating an image forming apparatus according to the first embodiment;

FIG. 3 is a block diagram illustrating a hardware configuration related to image formation in a control system that controls the image formation facility according to the first embodiment;

FIG. 4 is a schematic diagram illustrating a heating device according to the first embodiment;

FIG. 5 is a block diagram illustrating the control system for facility equipment according to the first embodiment;

FIG. 6 is a flowchart illustrating an operation performed by the control system according to the first embodiment;

FIG. 7 is a diagram illustrating one example of an air supply and exhaust amount setting table;

FIG. 8 is a diagram illustrating another example of the air supply and exhaust amount setting table;

FIG. 9 is a diagram illustrating still another example of the air supply and exhaust amount setting table;

FIG. 10 is a diagram illustrating yet another example of the air supply and exhaust amount setting table; and

FIG. 11 illustrates an air supply and exhaust amount setting graph.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described with reference to the drawings. In the drawings, elements such as members or components having the same function or shape are given the same reference numerals as long as the same function or shape can be determined, and redundant descriptions thereof are omitted.

### Overall Configuration of Image Formation Facility

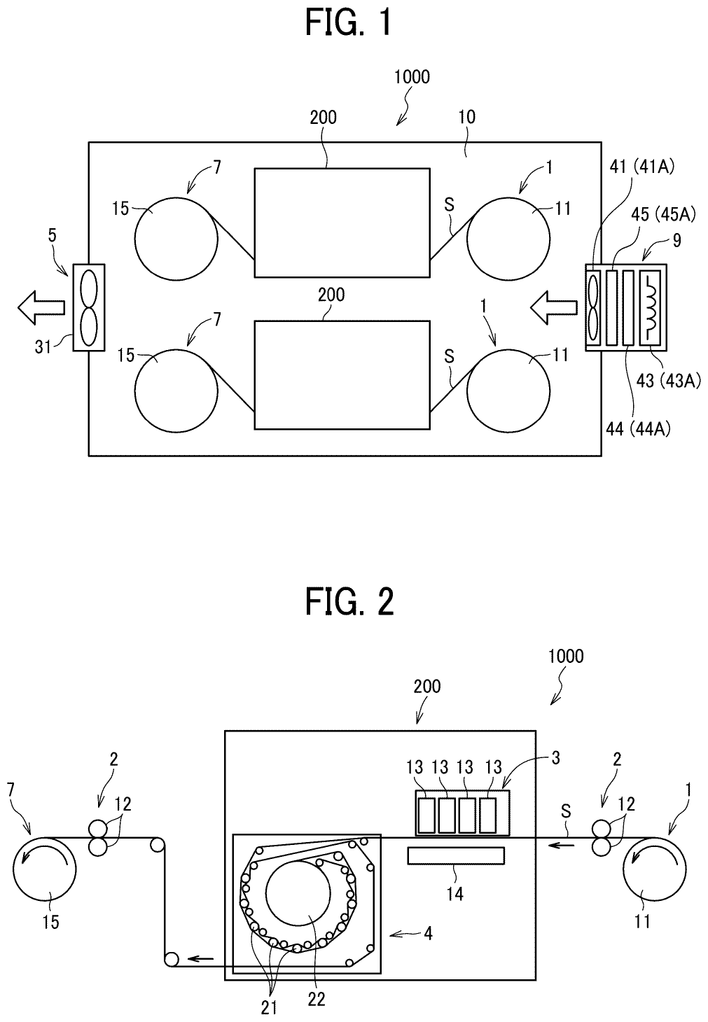

FIG. 1 is a schematic diagram illustrating an overall configuration of an image formation facility 1000 according to a first embodiment of the present disclosure.

As illustrated in FIG. 1, the image formation facility 1000 according to the first embodiment of the present disclosure includes an image forming apparatus 200, a sheet supply unit 1, a sheet collection unit 7, an exhaust device 5, and an air conditioner 9.

A plurality of image forming apparatuses 200 is placed in a space 10 that is partitioned by, for example, a wall of a building. The image forming apparatus 200 is one example of a liquid applying apparatus that applies liquid to a sheet (as an example of an object). In FIG. 1, although two image forming apparatuses 200 are placed, the number of the image forming apparatuses 200 may be one or three or more.

In the space 10 (hereinafter referred to as a facility space) in which the image forming apparatuses 200 are placed, a plurality of sheet supply units 1 and a plurality of sheet collection units 7 are placed as similar to the image forming apparatuses 200.

The sheet supply unit 1 supplies a sheet S to the image forming apparatus 200. Herein, the sheet supply unit 1 includes a supply roller 11 that supplies a roll sheet S. When the supply roller 11 is rotated, the sheet S is fed from the supply roller 11 and supplied. The sheet S may be a sheet that is cut beforehand in a predetermined size. In such a case, the sheet supply unit 1 includes a sheet feed roller that feeds predetermined-size sheets one by one.

The sheet collection unit 7 collects the sheet S to be ejected from the image forming apparatus 200. Herein, the sheet collection unit 7 includes a collection roller 15 that collects the sheet S by winding the sheet S. When the collection roller 15 is rotated, the sheet S is wound in a roll shape and collected by the collection roller 15. The sheet S may be a sheet that is cut beforehand in a predetermined size. In such a case, the sheet collection unit 7 includes an ejection tray on which sheets ejected to the outside of the image forming apparatus 200 are stacked.

The exhaust device 5 includes an exhaust fan 31 that exhausts the air inside the facility space 10 to the outside. When the exhaust fan 31 is driven, the air inside the facility space 10 is exhausted to the outside (the outside of the facility space 10). An exhaust device such as a blower may be used instead of the exhaust fan 31.

The air conditioner 9 adjusts air environment inside the facility space 10. The air conditioner 9 includes an air supply fan 41A as an air supplier 6 that supplies air to the inside of the facility space 10, a heater 43A as a heating unit 43 that heats the air to be supplied, a humidifier 44A as a humidifying unit 44 that humidifies the air to be supplied, and a dehumidifier 45A as a dehumidifying unit 45 that dehumidifies the air to be supplied. When the external air (the air outside the facility space 10) is introduced by the air supply fan 41A, a temperature and a humidity of the introduced air are adjusted by the heater 43A, the humidifier 44A, or the dehumidifier 45A, and the adjusted air is supplied to the facility space 10. A blower may be used as the air supplier 6.

### Configuration of Image Forming Apparatus

FIG. 2 is a schematic diagram illustrating the image forming apparatus 200 according to the first embodiment of the present disclosure.

As illustrated in FIG. 2, the image forming apparatus 200 includes a liquid applying device 3 and a heating device 4.

The liquid applying device 3 includes a plurality of liquid discharge units 13 that discharge liquid to a sheet S. The plurality of liquid discharge units 13 includes a plurality of liquid discharge heads that discharge different color liquid (ink) such as black, cyan, magenta, and yellow. The liquid discharge unit 13 may be an integrated (one) liquid discharge head that discharges different color liquid. A discharge method for the liquid discharge unit 13 is not particularly limited. Examples of the discharge method include an on-demand method by which micro droplets are discharged, and a continuous method by which liquid is continuously sprayed. Examples of the on-demand method include a pressure application method using a piezoelectric element as a drive source to discharge liquid, a thermal method by which liquid is discharged using a pressure generated by bubbles when liquid is heated, and an electrostatic method using an electrostatic force. The liquid to be discharged from the liquid discharge unit 13 is not limited to black, cyan, magenta, or yellow, and color of the liquid to be discharged from the liquid discharge unit 13 can be optionally selected. Moreover, in FIG. 2, a conveyance guide member 14 that guides the sheet S to be conveyed is disposed below the liquid discharge units 13.

The heating device 4 functions as a dryer that dries a sheet S by heating the sheet S. Particularly, the heating device 4 according to the first embodiment of the present disclosure includes a heating unit such as a heating roller 21 and a heating drum 22. The heating unit heats the sheet S. When a sheet S is conveyed to the heating device 4, the sheet S contacts the heating roller 21 and the heating drum 22. Thus, the sheet S is heated and dried. The heating unit is not limited to a contact-type heating unit such as the heating roller 21 and the heating drum 22. The heating unit may be a non-contact-type heating unit. In such a case, an infrared ray or an ultraviolet ray is emitted to a sheet S to heat the sheet S.

### Image Forming Operation

Next, an image forming operation performed by the image forming apparatus 200 according to the first embodiment of the present disclosure is described with reference to FIG. 2.

When the image forming apparatus 200 starts an operation, rotation of the supply roller 11 begins, and a sheet S is supplied from the supply roller 11.

The supplied sheet S is conveyed toward an area below the liquid discharge units 13 by a conveyance roller pair 12 of a conveyance unit 2, and liquid (ink) is discharged from each of the liquid discharge units 13 to the sheet S. Thus, an image is formed on the sheet S.

Subsequently, the sheet S is conveyed to the heating device 4. In the heating device 4, the sheet S contacts the heating roller 21 and the heating drum 22 while being conveyed, so that the sheet S is heated. Accordingly, the liquid on the sheet S evaporates, and the drying of the sheet S is accelerated.

Subsequently, the sheet S is ejected from the heating device 4, and is then conveyed to the collection roller 15 by the conveyance roller pair 12. The sheet S is then wound and collected by the collection roller 15 being rotated. Accordingly, a series of the image forming operations ends.

### Configuration of Controller

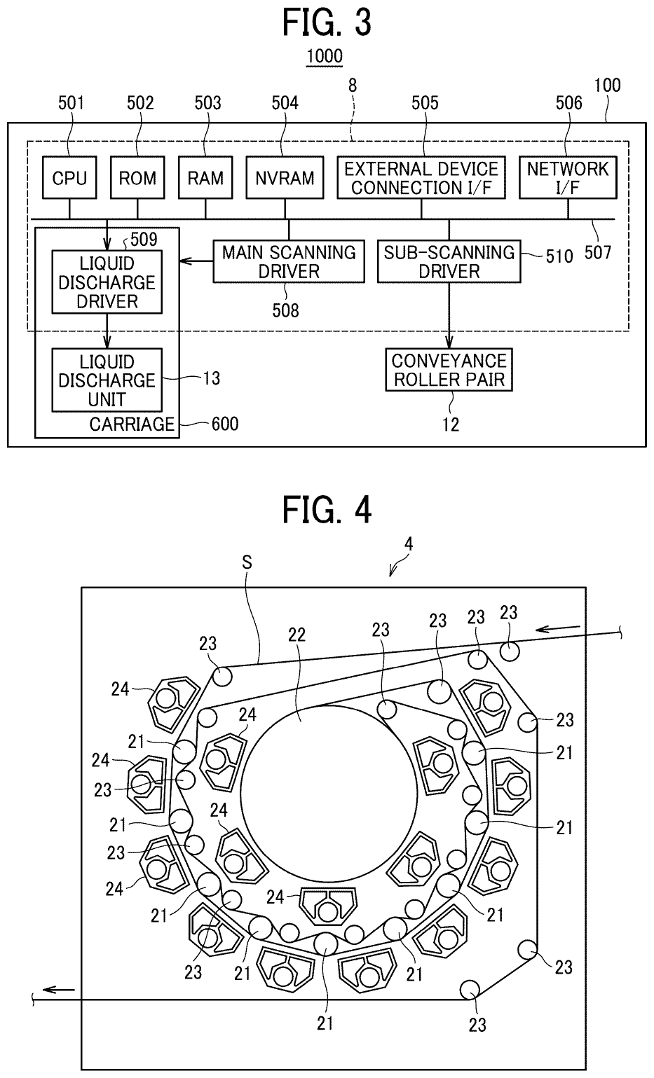

FIG. 3 is a block diagram illustrating a hardware configuration related to image formation in a control system 100 that controls the image formation facility 1000 according to the first embodiment.

The image formation facility 1000 is controlled by the control system 100. The control system 100 for facility equipment includes a controller 8 illustrated in FIG. 3. Particularly, the controller 8 includes a central processing unit (CPU) 501, a read only memory (ROM) 502, a random access memory (RAM) 503, a non-volatile random access memory (NVRAM) 504, an external device connection interface (I/F) 505, a network I/F 506, and a bus line 507.

The CPU 501 comprehensively controls operations of the image formation facility 1000. The ROM 502 stores, for example, a program such as an initial program loader (IPL) to be used to drive of the CPU 501. The RAM 503 is used as a work area of the CPU 501. The NVRAM 504 stores various data such as programs, and retains the various data even during which the power source of the image forming apparatus 200 is cut off.

The external device connection I/F 505 is connected to a personal computer (PC) by, for example, a universal serial bus (USB) cable, so that communication is performed between the external device connection I/F 505 and the PC to transmit and receive a control signal and data of an image to be printed. The network I/F 506 is an interface for data communication using a communication network such as the Internet. The bus line 507 is, for example, an address bus and a data bus for electrically connecting each of the elements such as the CPU 501.

Moreover, the controller 8 includes a main scanning driver 508 and a liquid discharge driver 509. The main scanning driver 508 controls movement of a carriage 600 in a main scanning direction (a sheet width direction). The liquid discharge units 13 are mounted on the carriage 600. The liquid discharge driver 509 is a driver that controls drive of the liquid discharge units 13. When the carriage 600 movies in a main scanning direction, the liquid discharge units 13 are moved in the main scanning direction (the sheet width direction) with the movement of the carriage 600, and liquid is discharged from the liquid discharge units 13 to a sheet to be intermittently conveyed. Accordingly, an image is formed on the sheet.

Moreover, the controller 8 includes a sub-scanning driver 510. The sub-scanning driver 510 controls conveyance of the sheet by the conveyance roller pair 12.

The liquid discharge unit 13 can be a serial-type liquid discharge head that discharges liquid to a sheet while moving in a sheet width direction, or a line-type liquid discharge head that discharges liquid to a sheet without movement. The liquid discharge driver 509 may not be mounted on the carriage 600, and may be connected to a bus line outside the carriage 600. Each of the main scanning driver 508, the liquid discharge driver 509, and the sub-scanning driver 510 can function according to a command issued by the CPU 501 based on a program.

### Configuration of Heating Device

FIG. 4 is a schematic diagram illustrating the heating device 4 according to the first embodiment of the present disclosure.

As illustrated in FIG. 4, the heating device 4 includes a guide roller 23 and an air spray device 24 in addition to the heating roller 21 and the heating drum 22.

Each of the heating roller 21 and the heating drum 22 is a cylindrical heating rotator with a heat source such as a halogen heater inside. In the first embodiment, one heating drum 22 having a larger diameter than the heating roller 21 is disposed in a middle portion of the heating device 4, and a plurality of heating rollers 21 is disposed around the heating drum 22. However, the arrangement of the heating rollers 21 and the heating drum 22 is not limited thereto, and the number of heating rollers 21 and the heating drums 22 is not limited thereto. The arrangement and the number of the heating rollers 21 and the heating drums 22 can be changed appropriately.

The guide roller 23 is a cylindrical rotator without a heat source inside. The guide roller 23 functions as a guide that guides a sheet S. A plurality of guide rollers 23 is disposed inside the heating device 4. When the sheet S is provided around the heating roller 21 and the heating drum 22 in addition to the guide roller 23, so that a conveyance path along which the sheet S is conveyed is configured.

The air spray device 24 is an air blower that blows air to the sheet S to accelerate the drying of the sheet S. A plurality of air spray devices 24 is disposed opposite the sheet S.

When a sheet S is conveyed inside the heating device 4 having such a configuration, the sheet S is guided by the guide roller 23 and is then provided around the outer side the heating roller 21. Herein, the term “outer side” of the heating roller 21 represents an opposite side relative to a side opposite the heating drum 22 within an outer circumferential surface of the heating roller 21. The sheet S has an image forming surface and a surface that is an opposite side of the image forming surface. The surface which is the opposite side of the image forming surface of the sheet S contacts the outer side of the heating roller 21, so that the sheet S is heated. Subsequently, the sheet S is wound around the heating drum 22. Then, the sheet S is guided again to the heating roller 21 from the heating drum 22, and is conveyed while contacting the inner side of the heating roller 21 (the inner side of the heating roller 21 represents the side opposite the heating drum 22).

Therefore, after the sheet S contacts the outer side of the heating roller 21, the sheet S is wound around the heating drum 22. Subsequently, the sheet S is conveyed while contacting the inner side of the heating roller 21, so that the surface which is the opposite side of the image forming surface of the sheet S is heated in an efficient manner. Moreover, since the air is blown to the image forming surface of the sheet S from the plurality of air spray devices 24, the drying of the sheet S is accelerated. Thus, the sheet S is dried, and the dried sheet S is ejected from the heating device 4 by the guide roller 23.

### Supply and Exhaust System

As described above, when the sheet S is heated by the heating device 4, moisture or a solvent contained in the liquid which has applied to the sheet S becomes steam and the steam is released. When the sheet S is heated, moisture contained in the sheet S also becomes steam and the steam is released. Such steam remains as gas for a while. Subsequently, when the steam is cooled inside the heating device 4 or the image forming apparatus 200, dew condensation occurs, and water droplets adhere to the sheet S. Such adhesion of the water droplets to the sheet S can cause a poor-quality image.

According to the first embodiment of the present disclosure, the air inside the facility space 10 is exhausted to the outside of the facility space 10 by the exhaust device 5 illustrated in FIG. 1. Accordingly, since the steam generated inside the heating device 4 is exhausted to the outside of the facility space 10, dew condensation can be prevented from occurring inside the heating device 4 and the image forming apparatus 200. Moreover, since the air inside the facility space 10 is exhausted to the outside of the facility space 10, the solvent generated from the sheet S is also exhausted to the outside of the facility space 10, thereby preventing degradation of air environment inside the facility space 10.

Herein, in a case in which the air is exhausted to the outside to prevent dew condensation, an air pressure inside the facility space 10 may fluctuate due with the exhaust of the air to the outside. Thus, air needs to be supplied to the inside of the facility space 10 at the same time as the exhaust of the air to the outside. When the outside air is introduced into the facility space 10 to supply the air, temperature and humidity inside the facility space 10 may fluctuate. Since the fluctuations in temperature and humidity inside the facility space 10 influence physical properties of liquid (ink) to be applied to a sheet, temperature and humidity inside the facility space 10 need to be adjusted when the air is supplied. In the first embodiment of the present disclosure, therefore, when air is exhausted to the outside of the facility space 10, the air conditioner 9 is used not only to supply air to the inside of the facility space 10, but also to adjust temperature and humidity of the air to be supplied. Accordingly, air pressure inside the facility space 10 can be maintained at a desired pressure, and air environment (temperature and humidity) suitable to maintain physical properties of liquid can be provided.

### Issues Concerning Supply and Exhaust System

An amount of steam generated from a sheet S changes depending on a state of the image forming apparatus 200. For example, if the image forming apparatus 200 is in an operation state in which the image forming apparatus 200 applies liquid to a sheet S, an amount of steam to be generated from the sheet S is large. On the other hand, if the image forming apparatus 200 is in a non-operation state, such as a standstill state or a standby state, in which the image forming apparatus 200 does not apply liquid to a sheet S, an amount of steam to be generated from the sheet S is small. The term “standstill state” used herein represents a state in which the power source of the image forming apparatus 200 is OFF. The term “standby state” used herein represents a power-saving state or a sleep state in which functions of the image forming apparatus 200 are partially stopped to reduce power consumption while the power source of the image forming apparatus 200 remains ON.

An exhaust amount of the exhaust device 5 and an air supply amount of the air conditioner 9 may be set suitable for a case where a steam amount is large. In such a case, if a steam amount is small, the exhaust device 5 and the air conditioner 9 are excessively operated. Consequently, operation energy is excessively consumed. The term “operation” used herein includes an output of a heater and drive of an element such as rotation of a fan. However, an exhaust amount and an air supply amount are conventionally set constant regardless of a steam amount, causing high energy consumption for exhaust of air to the outside and air conditioning.

The present disclosure proposes that the exhaust device 5 and the air conditioner 9 are controlled based on an amount of steam generated from a sheet S to reduce energy that is consumed due to excessive operation of the exhaust device 5 and the air conditioner 9. Hereinafter, characteristics of the present disclosure are described using the first embodiment as an example.

### Characteristics of Present Disclosure

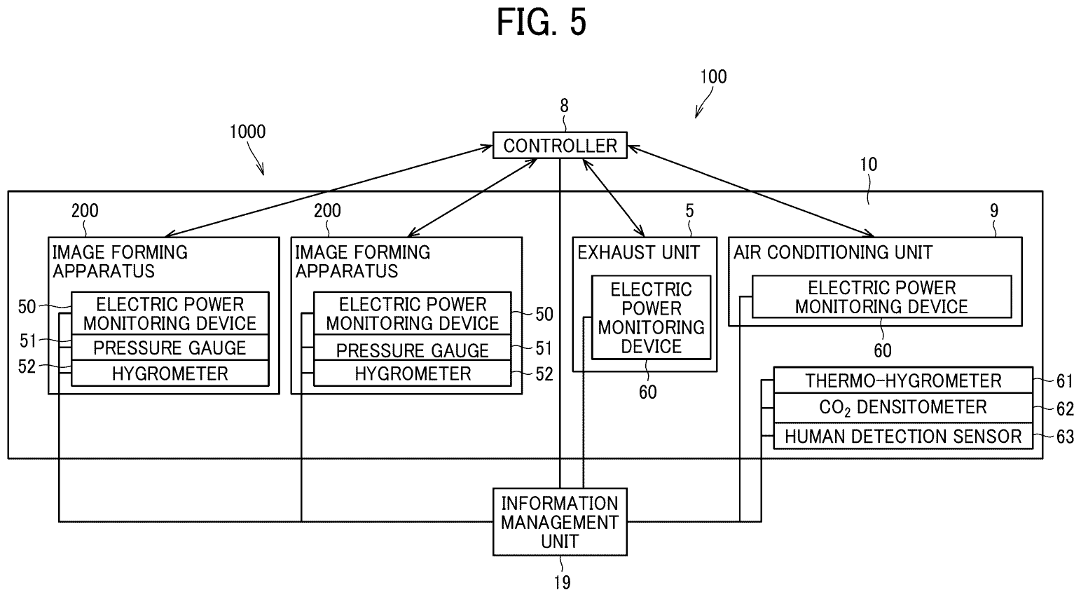

FIG. 5 is a block diagram illustrating the control system 100 for facility equipment according to the first embodiment of the present disclosure.

The control system 100 for facility equipment according to the first embodiment includes an information management unit 19 in addition to the controller 8 which controls the image forming apparatus 200, the exhaust device 5, and the air conditioner 9. The information management unit 19 collects information from various information acquisition devices placed inside the facility space 10 and manages the collected information.

In this case, the various information acquisition devices include electric power monitoring devices 50 and 60, a pressure gauge 51, a hygrometer 52, a thermo-hygrometer 61, a carbon dioxide (CO₂) densitometer 62, and a human detection sensor 63. The electric power monitoring device 50 acquires information about power consumption of the image forming apparatus 200, and the electric power monitoring devices 60 acquire respective pieces of information about power consumption of the exhaust device 5 and the air conditioner 9. The pressure gauge 51 acquires information about pressure inside the image forming apparatus 200. The hygrometer 52 acquires information about humidity inside the image forming apparatus 200. The thermo-hygrometer 61 acquires information about temperature and humidity inside the facility space 10. The CO₂ densitometer 62 acquires information about carbon dioxide density inside the facility space 10. The human detection sensor 63 acquires information about the presence or absence of a human inside the facility space 10. In FIG. 5, although the information management unit 19 and the image forming apparatus 200 are separately arranged, the information management unit 19 may be included in the image forming apparatus 200. The various information acquisition devices are not limited to devices for acquiring the power consumption information, the pressure information, the humidity information, the temperature information, the carbon dioxide density information, and the information about the presence or absence of a human. The various information acquisition devices can acquire other information about the inside of the facility space 10.

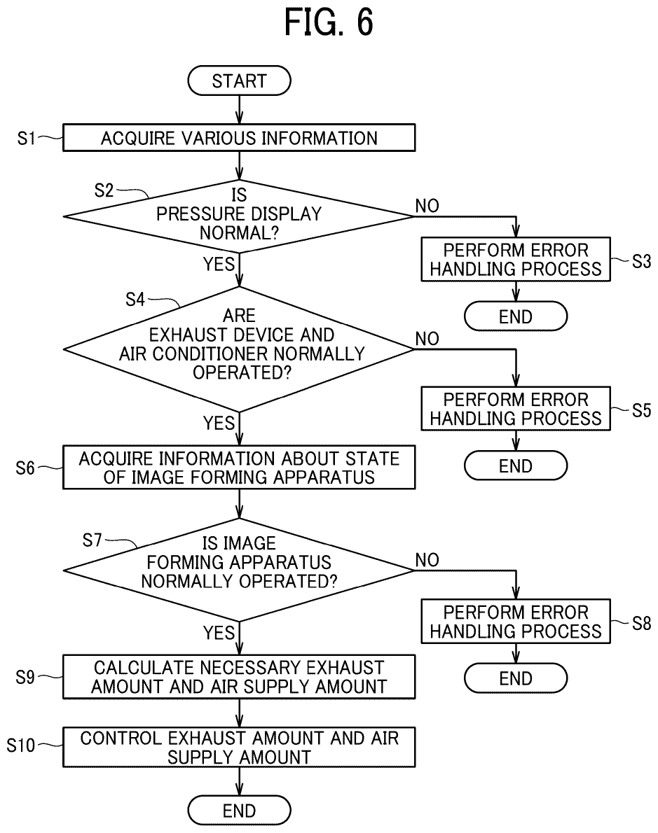

Next, an operation performed by the control system 100 according to the first embodiment is described with reference to FIG. 6.

As illustrated in FIG. 6, in step S1, the controller 8 acquires the information acquired by the various information acquisition devices (the electric power monitoring devices 50 and 60, the pressure gauge 51, the hygrometer 52, the thermo-hygrometer 61, the CO₂ densitometer 62, and the human detection sensor 63) from the information management unit 19.

Subsequently, in step S2, the controller 8 determines whether a pressure display of the pressure gauge 51 is normal based on the acquired pressure information. If the controller 8 determines that the pressure display is not normal (NO in step S2), the process proceeds to step S3 since an exhaust amount cannot be appropriately determined. In step S3, the controller 8 performs an error handling process. For example, the controller 8 stops an image forming operation. On the other hand, if the controller 8 determines that the pressure display is normal (YES in step S2), the process proceeds to step S4.

In step S4, the controller 8 determines whether the exhaust device 5 and the air conditioner 9 are normally operated. If the controller 8 determines that the exhaust device 5 and the air conditioner 9 are not normally operated (NO in step S4), the process proceeds to step S5. In step S5, the controller 8 performs an error handling process. For example, the controller 8 stops an image forming operation. On the other hand, if the controller 8 determines that the exhaust device 5 and the air conditioner 9 are normally operated (YES in step S4), the process proceeds to step S6.

In step S6, the controller 8 acquires information about a state of the image forming apparatus 200 (e.g., information about an operation state or a print condition). Subsequently, in step S7, the controller 8 determines whether the image forming apparatus 200 is normally operated based on the information about a state of the image forming apparatus 200. If the controller 8 determines that the image forming apparatus 200 is not normally operated (NO in step S7), the process proceeds to step S8. In step S8, the controller 8 performs an error handling process. For example, the controller 8 stops an image forming operation. On the other hand, if the controller 8 determines that the image forming apparatus 200 is normally operated (YES in step S7), the process proceeds to step S9. As illustrated in FIG. 1, in a case where there is a plurality of image forming apparatuses 200, the controller 8 checks an operation with respect to each image forming apparatus 200 (the processes in steps 6 and 7 are performed for each image forming apparatus 200). In such a case, if the controller 8 determines that each of the image forming apparatuses 200 is normally operated (YES in step S7), the process proceeds to step S9.

Subsequently, in step S9, based on the information about a state of the image forming apparatus 200, the controller 8 calculates a necessary exhaust amount and a necessary air supply amount. In step S10, the controller 8 controls the exhaust device 5 and the air conditioner 9 (the air supplier 6) based on the calculated exhaust amount and air supply amount. Thus, the exhaust amount and the air supply amount are adjusted to appropriate amounts. If there is a plurality of image forming apparatuses 200, the controller 8 calculates a necessary exhaust amount and a necessary air supply amount for each image forming apparatus 200 according to a state of each image forming apparatus 200, and controls the exhaust device 5 and the air conditioner 9 (the air supplier 6) based on a total of the calculated exhausted amounts and a total of the calculated air supply amounts.

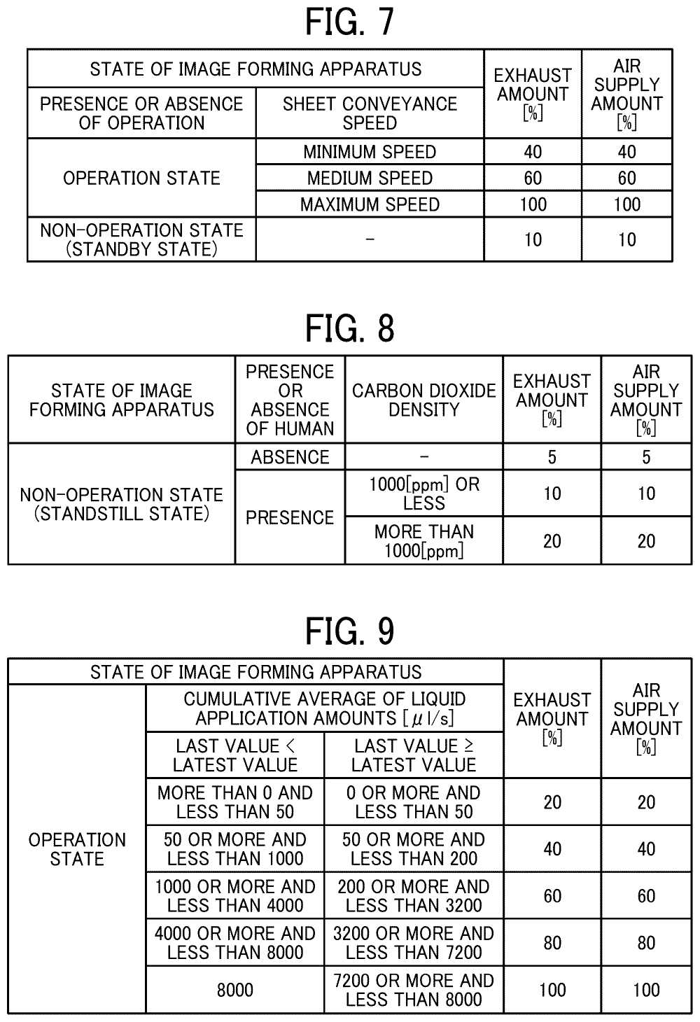

A necessary exhaust amount and a necessary supply amount can be determined by computation using information about a state of the image forming apparatus 200, or can be determined by using an air supply and exhaust amount setting table illustrated in FIG. 7. The supply and exhaust setting table is prepared beforehand.

In the air supply and exhaust amount setting table illustrated in FIG. 7, an exhaust amount and an air supply amount are set based on the presence or absence of an operation state of the image forming apparatus and information about sheet conveyance speed. Each of the presence or absence of an operation state and the sheet conveyance speed is one of pieces of information indicating a state of the image forming apparatus.

In general, when a sheet conveyance speed is increased, a sheet loading amount per unit time with respect to a heating device is increased. Thus, an amount of steam generated inside the heating device tends to be increased. Accordingly, in the air supply and exhaust amount setting table illustrated in FIG. 7, an exhaust amount and an air supply amount are set to be increased according to a sheet conveyance speed. On the other hand, if the image forming apparatus is in a non-operation state (a standby state), steam is barely generated because a sheet drying process is not performed. Thus, if the image forming apparatus is in the non-operation state, an exhaust amount and an air supply amount are set smaller than an exhaust amount and an air supply amount for the image forming apparatus in an operation state. The exhaust amount and the air supply amount in FIG. 7 represent rates [%] if a maximum exhaust amount of the exhaust device 5 is 100 [%] and a maximum air supply amount of the air conditioner 9 (the air supplier 6) is 100 [%]

According to the first embodiment of the present disclosure, the exhaust device 5 and the air conditioner 9 (the air supplier 6) are controlled according to a state (an operation state or a non-operation state) of the image forming apparatus 200, and thus an exhaust amount and an air supply amount can be adjusted according to an amount of steam to be generated. Thus, energy consumption due to excessive operation of the exhaust device 5 and the air conditioner 9 (the air supplier 6) can be reduced, and energy can be saved.

An amount of steam generated from a sheet is determined based on an operation state and a sheet conveyance speed of the image forming apparatus 200. In addition, an amount of steam generated from a sheet can be determined based on humidity information which is one of pieces of information indicating a state of the image forming apparatus 200. A humidity inside the image forming apparatus 200 can be detected using the hygrometer 52 illustrated in FIG. 5. The controller 8 controls the exhaust device 5 and the air conditioner 9 (the air supplier 6) based on the detected humidity, so that an exhaust amount and an air supply amount can be adjusted according to the steam amount.

Moreover, energy consumption for air conditioning can be reduced by reduction of an air supply amount of the air conditioner 9 (the air supplier 6) and reduction of an output of at least one of the heater 43A, the humidifier 44A, and the dehumidifier 45A of the air conditioner 9. Thus, at least one of the heater 43A, the humidifier 44A, and the dehumidifier 45A can be controlled according to a state of the image forming apparatus 200. The controller 8 controls the exhaust device 5, the air supplier 6, and at least one of the heater 43A, the humidifier 44A, and the dehumidifier 45A, so that energy consumption can be further reduced.

In the example illustrated in FIG. 7, the exhaust amount and the air supply amount are set to four different stages of 40 [%], 60 [%], 100 [%], and 10 [%]. However, the exhaust amount and the air supply amount can be set to two stages such as an operation state and a non-operation state (a standstill state or a standby state). That is, an operation level of each of the exhaust device 5 and the air conditioner 9 can be appropriately changed as long as at least two or more stages are provided.

Moreover, an exhaust amount and an air supply amount can be controlled by pulse width modulation (PWM) control of air volumes of the exhaust fan 31 and the air supply fan 41A. An air volume (Q [m³/h]) represents a volume of air moved by each of the exhaust fan 31 and the air supply fan 41A per unit time, and is expressed by a multiplier of a passing wind speed V [m/s] and a passing area A [m²]. An air volume can be measured using, for example, a hot-wire-type air speedometer or a vane-type air speedometer. Moreover, the exhaust amount and the air supply amount can be adjusted by adjustment of air volumes of the exhaust fan 31 and the air supply fan 41A or by changes in an opening amount of each of an exhaust duct and an air supply duct by a damper.

Next, another embodiment is described. Hereinafter, descriptions of differences from the first embodiment are mainly given, whereas descriptions of the similarities to the first embodiment may be omitted.

### Second Embodiment of Present Disclosure

If an image forming apparatus 200 is in a standstill state, steam is basically not generated from a sheet. Thus, an exhaust amount and an air supply amount can be maintained at low values. However, even if the image forming apparatus 200 is in a standstill state, a worker may be present inside a facility space 10. In such a case, a necessary amount of ventilation needs to be obtained such that a density of carbon dioxide is not increased. In a case where the air inside the facility space 10 is dry, not only a nozzle of a liquid discharge head (a liquid discharge unit 13) may be clogged, but also a sheet to be used in image formation may be dried. Consequently, even if the image forming apparatus 200 is in the standstill state, temperature environment and humidity environment inside the facility space 10 are preferably adjusted to prevent the dryness.

Accordingly, in the second embodiment of the present disclosure, an exhaust amount and an air supply amount are controlled based on environment information including the presence or absence of a human inside the facility space 10, a carbon dioxide density, a temperature, and a humidity in addition to a state (an operation state, a non-operation state) of the image forming apparatus 200.

FIG. 8 illustrates one example of an air supply and exhaust amount setting table that is set based on the presence or absence of a human inside the facility space 10 and a carbon dioxide density in addition to a state (an operation state, a non-operation state) of the image forming apparatus 200,

In the air supply and exhaust amount setting table illustrated in FIG. 8, even if the image forming apparatus 200 is in a standstill state, an exhaust amount and an air supply amount in a case where a human is present inside the facility space 10 are set greater than an exhaust amount and an air supply amount in a case where a human is absent inside the facility space 10. Moreover, if a human is present inside the facility space 10, and a carbon dioxide density inside the facility space 10 is high (more than 1000 [ppm]), an exhaust amount and an air supply amount are set greater than an exhaust amount and an air supply amount in a case where a carbon dioxide density is low (1000 [ppm] or less). The presence or absence of a human and a carbon dioxide density inside the facility space 10 can be detected by a human detection sensor 63 and a CO₂ densitometer 62 illustrated in FIG. 5.

According to the second embodiment, therefore, an exhaust amount and an air supply amount are set based on the presence or absence of a human and a carbon dioxide density inside the facility space 10, so that a necessary amount of ventilation for the facility space 10 can be obtained. That is, a controller 8 controls an exhaust device 5 and an air conditioner 9 based on human detection information acquired by the human detection sensor 63 and carbon dioxide density information acquired by the CO₂ densitometer 62. Hence, an exhaust amount and an air supply amount can be adjusted according to the presence or absence of a human and a carbon dioxide density, thereby providing good facility environment.

The controller 8 can control the exhaust device 5 and the air conditioner 9 based on a temperature and a humidity, other than the presence or absence of a human and a carbon dioxide density. A temperature and a humidity inside the facility space 10 can be detected by a thermo-hygrometer 61 illustrated in FIG. 5. The controller 8 controls a heater 43A, a humidifier 44A, or a dehumidifier 45A of the air conditioner 9 in addition to the exhaust device 5 based on the information about the temperature and the humidity detected by the thermo-hygrometer 61. Thus, environment can be adjusted to appropriate temperature environment and appropriate humidity environment, thereby preventing clogging of a nozzle of a liquid discharge head and dryness of a sheet. The control performed by the controller 8 on the exhaust device 5 and the air conditioner 9 is not limited to a case where the controller 8 controls the exhaust device 5 and the air conditioner 9 based on all of the environment information that is human detection information, a carbon dioxide density, a temperature, and a humidity. The controller 8 may control the exhaust device 5 and the air conditioner 9 based on at least one of human detection information, a carbon dioxide density, a temperature, and a humidity.

### Third Embodiment of Present Disclosure

An amount of steam to be generated from a sheet by a drying process changes depending on not only an operation state and a non-operation state of an image forming apparatus, but also liquid application conditions that are used when liquid is applied to a sheet. Examples of the liquid application conditions include an amount of liquid to be applied to a sheet, a sheet conveyance speed, a sheet type, and a sheet thickness. For example, in a case where an image area rate or an image density of an image to be formed on a sheet is high, an amount of liquid to be applied to a sheet (a liquid application amount) is increased. Consequently, an amount of steam to be generated from the sheet by a drying process tends to be increased. In a case where a sheet conveyance speed is high, a sheet loading amount per unit time with respect to a heating device is greater than a case in which a sheet conveyance speed is low. Consequently, an amount of steam generated inside the heating device is increased. Since the steam generated from the sheet includes steam generated from liquid and steam generated by evaporation of moisture contained in the sheet, an amount of steam differs depending on a sheet thickness or a type of sheet having a different water content.

Accordingly, in the third embodiment, an exhaust device 5 and an air conditioner 9 are controlled in consideration of not only an operation state and a non-operation state of the image forming apparatus but also liquid application conditions including a liquid application amount, a sheet conveyance speed, a sheet type, and a sheet thickness as information about a state of the image forming apparatus.

FIG. 9 is an example of an air supply and exhaust amount setting table in which an exhaust amount and an air supply amount are set based on a liquid application amount which is one of the liquid application conditions.

In the air supply and exhaust amount setting table illustrated in FIG. 9, an exhaust amount and an air supply amount are set based on a liquid application amount with respect to a sheet per unit time or per unit length. A controller 8 uses the air supply and exhaust amount setting table illustrated in FIG. 9 to determine a necessary exhaust amount and a necessary air supply amount. Particularly, the controller 8 acquires information about a liquid application amount of an image forming apparatus 200, and calculates a cumulative average of liquid application amounts for each unit time or each unit length from the acquired liquid application amount information. Then, the controller 8 compares the calculated cumulative average (the latest value) with a cumulative average (the last value) calculated last time. In each of cases where the latest value is greater than the last value, and the latest value is equal to the last value or less, the controller 8 controls the exhaust device 5 and an air supplier 6 based on the exhaust amount and an air supply amount illustrated in FIG. 9. The exhaust amount and the air supply amount illustrated in FIG. 9 are set for each cumulative average range.

According to the third embodiment, therefore, an exhaust amount and an air supply amount are controlled based on a liquid application amount, so that the exhaust amount and the air supply amount can be adjusted according to an amount of steam to be generated from a sheet. Thus, steam inside the image forming apparatus can be more reliably exhausted to the outside of the image forming apparatus while saving energy.

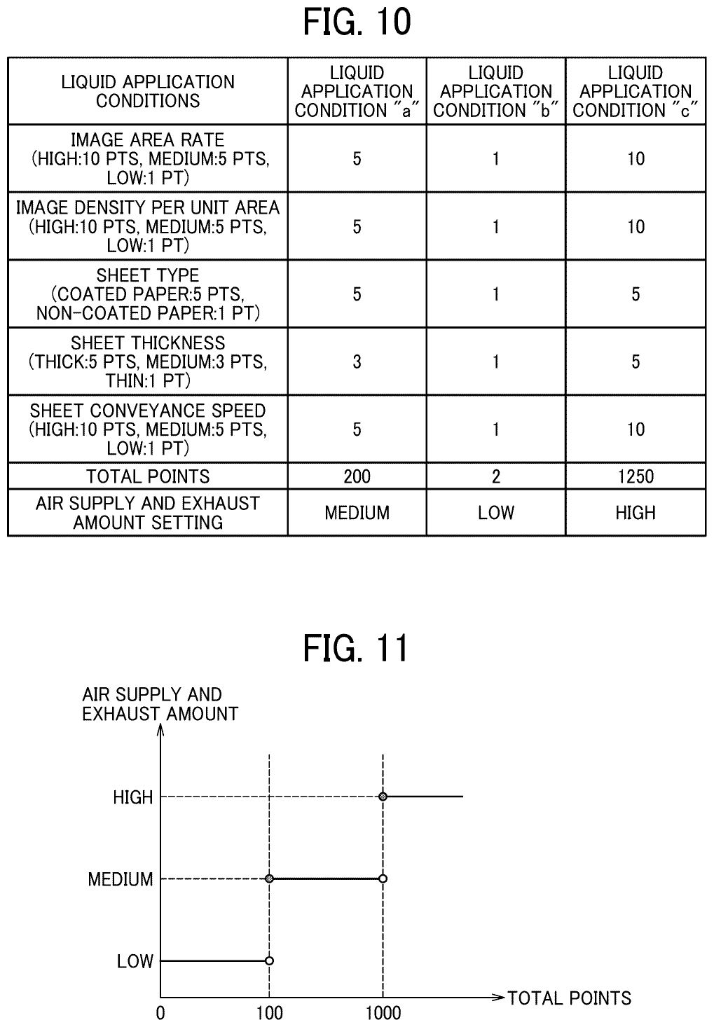

In a case where the controller 8 has difficulty in directly acquiring information about a liquid application amount, the controller 8 can indirectly calculate a liquid application amount from an image area rate and an image density. Alternatively, as illustrated in FIG. 10, an air supply and exhaust amount setting table in which a steam amount is scored beforehand for each liquid application condition may be prepared, and an exhaust amount and an air supply amount may be set using such an air supply and exhaust amount setting table. In the example illustrated in FIG. 10, the liquid application conditions include an image area rate, an image density per unit area, a sheet type, a sheet thickness, and a sheet conveyance speed. Moreover, an amount of steam to be generated is set to a scored value (see points in parentheses in FIG. 10). For example, if a liquid application condition “a” in the table illustrated in FIG. 10 is used as the liquid application conditions, an image area rate is set to medium of 5 points, an image density per unit area is set to medium of 5 points, a sheet type is set to 5 points for coated paper, and a sheet conveyance speed is set to medium of 5 points. Based on these points, the controller 8 calculates total points using the following expression.

Total points=(points for image area rate)×(points for image density per unit area)×(points for sheet conveyance speed)+(points for sheet type)×(points for sheet thickness)×(points for sheet conveyance speed) Expression 1

For example, in the liquid application condition “a”, the total points are calculated to 200 by Expression 1 above. Then, the controller 8 refers to an air supply and exhaust amount setting graph illustrated in FIG. 11, and controls the exhaust device 5 and the air supplier 6 based on an air supply amount and an exhaust amount corresponding to the total points. In the example illustrated in FIG. 11, an exhaust amount and an air supply amount are set in stages. If total points are more than zero and less than 100, an exhaust amount and an air supply amount are set to “low”. If total points are 100 or more and less than 1000, an exhaust amount and an air supply amount are set to “medium”. If total points are 1000 or more, an exhaust amount and an air supply amount are set to “high”. Since the liquid application condition “a” has the total points of 200, an exhaust amount and an air supply amount are set to “medium”.

Accordingly, an exhaust amount and an air supply amount are controlled based on liquid application conditions that are used when liquid is applied to a sheet, so that the exhaust amount and the air supply amount can be adjusted according to an amount of steam to be generated from the sheet. Thus, steam inside the image forming apparatus can be more reliably exhausted to the outside of the image forming apparatus while saving energy.

The control performed by the controller 8 on the exhaust device 5 and the air conditioner 9 is not limited to a case where the controller 8 controls the exhaust device 5 and the air conditioner 9 based on all of the liquid application conditions which are an image area rate, an image density, a sheet type, a sheet thickness, and a sheet conveyance speed. The controller 8 may control the exhaust device 5 and the air conditioner 9 based on at least one of an image area rate, an image density, a sheet type, a sheet thickness, and a sheet conveyance speed.

Each of the embodiments of the present disclosure has been described. However, the present disclosure is not limited to the above-described embodiments. Two or more embodiments out of the above-described embodiments may be combined. Modifications are possible as appropriate without departing from scope of the disclosure.

The present disclosure is applied to a control system for facility equipment including an image forming apparatus and a control method for the facility equipment, but is not limited thereto. The present disclosure may also be applied to a control system for other facility equipment and a control method for such facility equipment. For example, the present disclosure can be applied to a control system for facility equipment including a liquid applying apparatus that applies liquid such as processing liquid for modifying a sheet surface to a sheet prior to image formation, and a control method for such facility equipment. In addition, the present disclosure can be applied to a control system for facility equipment including a liquid applying apparatus that applies liquid to a sheet by a method other than a discharge method, for example, liquid is applied to a sheet by using a roller, and a control method for such facility equipment. A heating device to be included in the facility equipment can be a device that heats a sheet to fix an image on the sheet, instead of drying the sheet.

The sheet used in the present disclosure is matter to which liquid can adhere at least temporarily, and the sheet can be matter to which liquid adheres and is then fixed, or can be matter to which liquid adheres and then through which the liquid permeates. Particularly, examples of the sheet include paper, a resin film, wallpaper, and an electronic substrate. Moreover, the sheet can be made of a material such as paper, leather, metal, plastic, glass wood, or ceramic. The sheet is not limited to a long sheet that is continuously conveyed without stopping from a sheet supply unit to a sheet collection unit. The sheet can be a short sheet that is independently conveyed on a sheet basis, instead of being continuously conveyed, from a sheet supply unit to a sheet collection unit.

Although the liquid to be applied to the sheet is not particularly limited, examples of the liquid include a solution, a suspension, or an emulsion contain, for example, a solvent such as water or an organic solvent, a colorant such as dye or pigment, a functional material such as a polymerizable compound, a resin, or a surfactant, a biocompatible material such as deoxyribonucleic acid (DNA), amino acid, protein, or calcium, or an edible material such as a natural colorant. Such a solution, a suspension, or an emulsion can be used for, for example, inkjet ink, a surface treatment solution, liquid for forming an electronic element component, a light-emitting element component, or an electronic circuit resist pattern, or a material solution for three-dimensional fabrication.

According to the above-described embodiments, therefore, the present disclosure has at least the following aspects.

### First Aspect

A control system for facility equipment includes a liquid applying apparatus, an exhaust device, an air conditioner, and a controller. The liquid applying apparatus includes a liquid applying device to apply liquid to an object, and a heating device to heat the object on which the liquid has been applied. The exhaust device exhausts the air inside a space in which the liquid applying apparatus is placed. The air conditioner adjusts air environment inside the space. The controller controls the exhaust device and the air conditioner according to a state of the liquid applying apparatus.

### Second Aspect

In the control system according to the first aspect, the air conditioner includes an air supplier that supplies air to the inside of the space, and the controller controls the exhaust device and the air supplier according to a state of the liquid applying apparatus.

### Third Aspect

In the control system according to the second aspect, in a case where there is a plurality of liquid applying apparatuses including the liquid applying apparatus, the controller calculates an exhaust amount and an air supply amount according to a state of the liquid applying apparatus for each of the plurality of liquid applying apparatuses, and controls the exhaust device and the air supplier based on a total of calculated exhausted amounts and a total of calculated air supply amounts.

### Forth Aspect

In the control system according to the second or third aspect, the air conditioner includes the air supplier, a heating unit that heats the air to be supplied, a humidifying unit that humidifies the air to be supplied, and a dehumidifying unit that dehumidifies the air to be supplied. The controller controls the exhaust device, the air supplier, and at least one of the heating unit, the humidifying unit, and the dehumidifying unit according to a state of the liquid applying apparatus.

### Fifth Aspect

In the control system according to any one of the first through fourth aspects, the state of the liquid applying apparatus includes information about an operation state and a non-operation state of the liquid applying apparatus.

### Sixth Aspect

In the control system according to any of the first through fifth aspects, the state of the liquid applying apparatus includes a liquid application condition that is used when liquid is applied to the object.

### Seventh Aspect

In the control system according to the sixth aspect, the liquid application condition includes at least one of an amount of liquid to be applied to the object, a conveyance speed of the object when the object is conveyed by the liquid applying apparatus, a type of the object, and a thickness of the object.

### Eighth Aspect

In the control system according to any one of the first through seventh aspects, the state of the liquid applying apparatus includes humidity inside the liquid applying apparatus.

### Ninth Aspect

In the control system according to any one of the first through eighth aspects, the controller controls the exhaust device and the air conditioner based on environment information about the space in addition to the state of the liquid applying apparatus.

### Tenth Aspect

In the control system according to the ninth aspect, the environment information includes at least one of human detection information, a carbon dioxide density, a temperature, and a humidity.

### Eleventh Aspect

In the control system according to any one of the first through tenth aspects, the controller changes an operation level of each of the exhaust device and the air conditioner to at least two stages or more to control an exhaust amount and an air supply amount.

### Twelfth Aspect

In the control system according to any one of the first through eleventh aspects, the liquid applying apparatus is an image forming apparatus that applies liquid to the object to form an image.

### Thirteenth Aspect

A control method for facility equipment includes controlling. The controlling controls an exhaust device that exhausts air inside a space in which a liquid applying apparatus that applies liquid to an object is placed, and an air conditioner that adjusts air environment inside the space according to a state of the liquid applying apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A control system for facility equipment comprising:
a liquid applying apparatus including:
a liquid applying device to apply liquid to an object; and
a heating device to heat the object on which the liquid has been applied;
an exhaust device to exhaust air inside a space in which the liquid applying apparatus is placed;
an air conditioner to adjust air environment inside the space; and
processing circuitry to control the exhaust device and the air conditioner according to a state of the liquid applying apparatus.

2. The control system according to claim 1,
wherein the air conditioner includes an air supplier to supply air to an inside of the space, and
wherein the processing circuitry controls the exhaust device and the air supplier according to a state of the liquid applying apparatus.

3. The control system according to claim 2,
further comprising a plurality of liquid applying apparatuses including the liquid applying apparatus,
wherein the processing circuitry calculates an exhaust amount and an air supply amount according to a state of the liquid applying apparatus for each of the plurality of liquid applying apparatuses, and controls the exhaust device and the air supplier based on a total of calculated exhausted amounts and a total of calculated air supply amounts.

4. The control system according to claim 2,
wherein the air conditioner includes:
the air supplier;
a heater to heat air to be supplied;
a humidifier to humidify air to be supplied; and
a dehumidifier to dehumidify air to be supplied, and
wherein the processing circuitry controls the exhaust device, the air supplier, and at least one of the heater, the humidifier, and the dehumidifier according to a state of the liquid applying apparatus.

5. The control system according to claim 1,
wherein the state of the liquid applying apparatus includes information about an operation state and a non-operation state of the liquid applying apparatus.

6. The control system according to claim 1,
wherein the state of the liquid applying apparatus includes a liquid application condition that is used when liquid is applied to the object.

7. The control system according to claim 6,
wherein the liquid application condition includes at least one of an amount of liquid to be applied to the object, a conveyance speed of the object when the object is conveyed by the liquid applying apparatus, a type of the object, and a thickness of the object.

8. The control system according to claim 1,
wherein the state of the liquid applying apparatus includes humidity inside the liquid applying apparatus.

9. The control system according to claim 1,
wherein the processing circuitry controls the exhaust device and the air conditioner based on environment information about the space in addition to the state of the liquid applying apparatus.

10. The control system according to claim 9,
wherein the environment information includes at least one of human detection information, a carbon dioxide density, a temperature, and a humidity.

11. The control system according to claim 1,
wherein the processing circuitry changes an operation level of each of the exhaust device and the air conditioner to at least two stages or more to control an exhaust amount and an air supply amount.

12. The control system according to claim 1,
wherein the liquid applying apparatus is an image forming apparatus to apply liquid to the object to form an image.

13. The control system according to any one of claims 1 to 12,
wherein the object is a sheet.

14. A control method for facility equipment, comprising:
controlling an exhaust device to exhaust air inside a space in which a liquid applying apparatus to apply liquid to an object is placed, and an air conditioner to adjust air environment inside the space according to a state of the liquid applying apparatus.
